(19) United States
(12) Patent Application Publication
(10) Pub. No.: US 2022/0381075 A1
(43) Pub. Date: Dec. 1, 2022

(54) SLIDING SUPPORT DEVICE

(71) Applicant: IRONBOX S.R.L., Spresiano (IT)

(72) Inventors: Adriano GIROTTO, Spresiano (IT); Luca CESARETTI, Spresiano (IT); Lorenzo Andrea PARROTTA, Spresiano (IT)

(21) Appl. No.: 17/781,096

(22) PCT Filed: Dec. 4, 2020
(86) PCT No.: PCT/IB2020/061484

§ 371 Date: May 31, 2022

(30) Foreign Application Priority Data
Dec. 4, 2019 (IT) 102019000023004

(51) Int. Cl. E05D 15/06; E05F 15/632

(52) U.S. Cl. CPC E05D 15/0626; E05D 15/0656; E05F 15/632; E05D 2015/0695; E05Y 2201/41; E05Y 2201/428; E05Y 2201/46; E05Y 2900/102; E05Y 2900/132; E05Y 2900/202; E05Y 2900/204

(57) ABSTRACT

A support device for slidingly supporting, and linearly moving along a longitudinal axis, an object such as e.g. a leaf.

On the object a magnetic return force develops generated by the cooperation of a magnetic flux generator (54, 56) and an element reactive to the magnetic field. The element can slide parallel to the axis during the displacement of the object and correspondingly exhibits a section which, seen in a plane orthogonal to the axis, has a width that varies along the length of the first element parallel to said axis.

The invention relates to a device for slidingly supporting and linearly moving an object along an axis. The object is e.g. a door or a leaf for a window, for interior, or for a refrigerating cell, herein below chosen as a principal example.

Refrigerated counters or cells commonly have one or more sliding doors to open the refrigerated space in which food is stored. Especially for vertical counters, the doors are large and heavy. To minimize bulk and avoid hinges, the doors are mounted horizontally sliding back and forth, but they are not always user-friendly. Their considerable weight requires complicated and expensive guiding systems, often assisted by counterweights, to allow any user to easily use the counter.

To improve thermal efficiency, doors are prevented from opening accidentally by temporarily locking them when closed with magnetic means, see e.g. U.S. Pat. No. 2,446,336, which however sometimes require excessive effort to release them. Both when vigorously pulling the door to unlock the magnetic catch and when closing the door under the thrust of the counterweights, it may happen that the door bangs against the end stops. Such impacts damage the counter, so damping devices are introduced into the structure.

Another known shortcoming of the prior art is that locking/return devices based on molded profiles are subject to rapid wear.

It is then understood that the door structure is very expensive, complicated and nevertheless often not very user-friendly.

The main object of the invention is then to overcome one or more of these problems by proposing a device for slidingly supporting and linearly moving an object along an axis, where e.g. the device is easy to construct and reliable.

Another object is to make a device for slidingly supporting and linearly moving a door, e.g. of a refrigerating counter, in order to overcome one or more of the above problems.

A first aspect of the invention relates to a support device for slidingly supporting, and linearly moving along a longitudinal axis, an object such as a door, comprising:

an empty channel extending parallel to the longitudinal axis,

a generator of, or means for generating a, magnetic flux for creating a magnetic flux crossing a segment of the empty channel with magnetic field lines all equiverse,

a first element, reactive to the magnetic field, which is mounted in the empty channel and extends along said longitudinal axis,

the first element being able to slide relative to the channel parallel to the longitudinal axis during the object's displacement,

wherein the first element at said segment exhibits a cross-section that, viewed in a plane orthogonal to the longitudinal axis, has a dimension (width) along the width of the channel, wherein

the first element comprises—or consists of—a displaceable element (or means) for increasing or decreasing the width of said cross-section, i.e. the first element is configured so that a movement thereof results in an increase or decrease in the width of said segment.

E.g. the displaceable element (or the equivalent means) is configured to achieve an increase or decrease in width of said cross-section by displacing to enter into the channel or by displacing to get out of the channel, respectively.

E.g. the displaceable element (or equivalent means) can achieve an increase or decrease in width of said cross-section by cooperating with a fixed part within the channel.

The displaceable element and said fixed part (when present) are made of ferromagnetic material.

Since the magnetic flux prefers a path that hits more ferromagnetic material (the part with larger cross-section) a force develops correspondingly that drags the first element relative to the magnetic field generator. Then, by the displacement of the displaceable element into or out of the channel a path can be created with less or more reluctance for the magnetic flux, so that a drag force for the device arises.

For example, by the displacement of the displaceable element the door can be moved from right to left, or vice versa.

The variation along the longitudinal axis of the cross-section size, viewed in a plane orthogonal to the longitudinal axis, of the first element induces a magnetic return force between the first element and the magnetic field lines present in the channel segment.

The physical explanation is that at the point where the above dimension (or width) of the cross-segment is reduced (increased), and only at that point, a force develops tending to move relatively along the longitudinal axis the first element with respect to the channel so that the segment of the first element with smaller (larger) cross-section gets out of (gets into) the empty channel, i.e. so that said segment with smaller (larger) cross-section is no longer (is more) hit by magnetic field lines.

In essence, the magnetic force tends to move the system toward an equilibrium condition in which throughout the empty channel the first element has a cross-section with a larger size, corresponding to the minimum reluctance configuration.

Then by means of said displaceable element one can vary the cross-section of the first element along the longitudinal axis in such a way that a magnetic return force is created tending to bring the first element and the channel back to a certain relative position, in particular to bring a door back to the closed position.

Generally, the cross-section of the first element may be reduced up to the case of complete zeroing (of reactive material) within the channel. In such a case, the length along the longitudinal axis of the variable cross-section segment of the first element may be shorter than that of the channel segment with magnetic field lines all equiverse.

The cross-section of the first element can be reduced in various ways: e.g. with a step discontinuity or a smoother tapering.

In other words, said segment of the first element may vary from one point to another of the first element along said longitudinal axis, continuously or abruptly. In any case, said cross-section with variable size (width) has a cross-section increment along one direction of the longitudinal axis.

The inversion of the direction of the magnetic force may be obtained with only one movable cross-section (only one displaceable element) cooperating with another fixed cross-section of the first element. It is sufficient, for example, that the overall cross-section relative to the segment in correspondence of the displaceable element is different from that of the fixed segment.

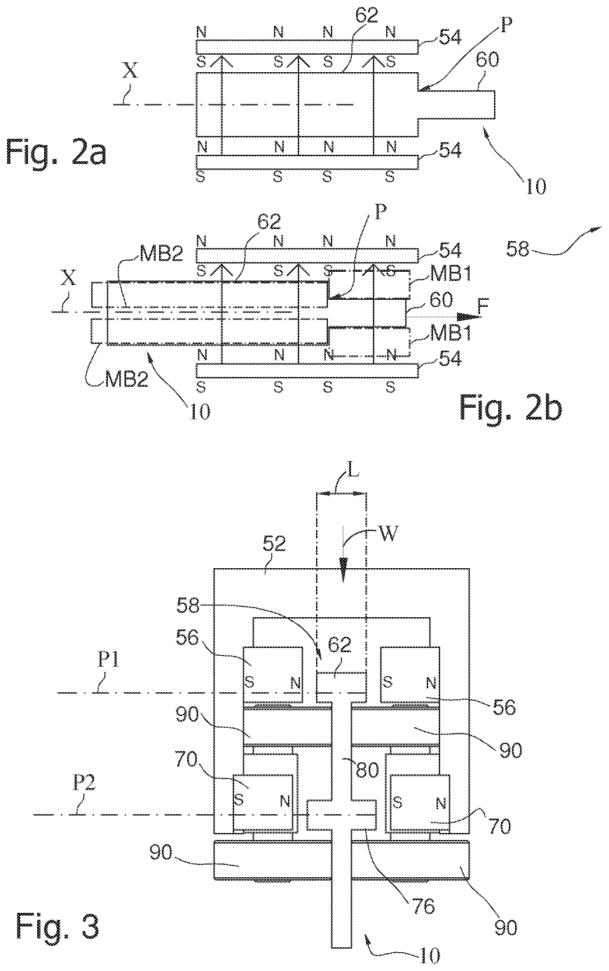

For example, in FIG. 2a one can imagine enlarging the cross-section 60 to make it larger than the cross-section 62 or reducing it to make it smaller than the cross-section 62. Or one can imagine enlarging the cross-section 62 to make it larger than the cross-section 60 or reducing it to make it smaller than the cross-section 60. It is the proportion between the two cross-sections that develops the dragging force. To vary the two cross-sections or their proportions one can, for example, juxtapose or remove a displaceable ferromagnetic element MB1 or MB2 shown with dashed lines in FIG. 2b.

In a preferred variant, the first element comprises—or consists of—a displaceable element (or means) for increasing or decreasing the width of a first cross-section of the first element viewed in a plane orthogonal to the axis, and simultaneously decreasing or increasing, respectively, the width of a second cross-section of the first element viewed in a plane orthogonal to the axis, and vice versa,

the first and second cross-sections being aligned inside the empty channel along the channel axis and being hit by the magnetic flux.

This provides a simultaneous reversal of the two cross-sections to reverse the direction of the magnetic force, and the use of a fixed cross-section can be avoided.

E.g. in this case as a displaceable ferromagnetic element one can consider an element given by the integral union of the elements MB1 and MB2 shown with dashed lines in FIG. 2b.

In particular, the first element
comprises
   two parts aligned along the axis and integral with each other,
   each part comprising a first and second portion adapted to engage the empty channel and respectively exhibit therein a cross-section which, viewed in a plane orthogonal to the axis, has a first and second dimension along the width of the channel,
   the first dimension being larger than the second dimension, and
   the larger dimensioned cross-section of the first part being aligned with the smaller dimensioned cross-section of the second part, and
   the smaller dimensioned cross-section of the first part being aligned with the larger dimensioned cross-section of the second part,
and is mounted movable relative to the generator to alternately place the smaller-sized portion of one part and the larger-sized portion of the other part inside the channel.

The first element and/or said displaceable element thereof may be movably mounted with respect to said longitudinal axis (and with respect to the generator of, or means for generating a, magnetic flux) between at least two positions, and is configured so that, when commuting from one position to the other, for said cross-section there is a reversal, along the longitudinal axis, of the direction along which there is a cross-section increase. That is to say that the commutation of the first element from one position to the other causes that, taken as reference a direction along said axis, while before the commutation the cross-section had an increasing trend along the reference direction, after the commutation the cross-section has a decreasing trend along the reference direction, or vice versa.

Thus by positional commutation of the first element or its displaceable element, the direction of the magnetic force acting between the first element and the generator of, or means for generating a, magnetic flux can be reversed.

In particular, in order to obtain said inversion, the first element comprises two parts that are mutually integral, adjacent (not necessarily contiguous), and both extending along said axis. Each said part, according to whether the first element is in the first or second of said two positions, respectively may have, in correspondence of said segment, two cross-sections which, viewed in a plane orthogonal to the longitudinal axis, have a different dimension (width) along the width of the channel. And in each of said two positions, each part has a cross-section, viewed in a plane orthogonal to the longitudinal axis, which has a different dimension (width), along the width of the channel, from that of the other part.

Namely, called S11 the cross-section of the first part in the first position, called S12 the cross-section of the first part in the second position, called S21 the cross-section of the second part in the first position, and called S22 the cross-section of the second part in the second position,

it is S11>S12; S21<S22, S11>S21, and S12<S22.

Therefore, in each of said two positions there is a cross-section discontinuity along the first element (such as point P or 100P in the attached figures), given by the cross-section diversity of the two parts.

A commutation of the first element from one of these two positions to the other causes the respective cross-sections, of each part, to swap inside the empty channel.

Because of what was said before, it follows that the aforementioned commutation of the first element inverts the order relationship between the cross-sections, of the two parts, that are simultaneously present inside the channel and that simultaneously interact with said generator of, or means for generating a, magnetic flux (if, before the commutation, one part had a smaller cross-section than the other part, after the commutation the same part has a larger one, and vice versa).

Therefore, by means of such commutation the direction of the magnetic force acting on the skid can be reversed, or the magnetic force acting on the skid can be activated or terminated.

Note that in the variant of the first element with only a displaceable part extending along said axis, such part, depending on whether the first element is in the first or second of said two positions, respectively may have, in correspondence to said segment, two cross-sections which, viewed in a plane orthogonal to the longitudinal axis, have a different dimension (width) along the width of the channel. That is, called S11 the cross-section of the only displaceable part, viewed in a plane orthogonal to the longitudinal axis, in the first position, and called S12 the cross-section of the only displaceable part, viewed in a plane orthogonal to the longitudinal axis, in the second position, it is S11>S12.

The first element or its displaceable element may be, for example, rotatable about an axis parallel to said longitudinal axis, and/or may be translatable orthogonally to said longitudinal axis. These displacements make it possible to replace within the empty channel the cross-section of each part with a corresponding cross-section of a different width.

In the case of a rotatable first element or a rotatable displaceable element, a preferred variant envisages that each part has a rectangular or substantially rectangular cross-section, and that said two cross-sections are arranged so that

the rotation axis of the first element passes through the crossing of the diagonals of each cross-section, and

the long sides of one cross-section are parallel to the short sides of the other cross-section.

E.g. the first element may be formed by two adjacent rectangular-cross-sectioned parallelepipeds, which are coaxial and offset by 90 degrees about the common rotation axis.

Or the first element may be formed by a circular cross-section bar grooved or cut along two chords of the cross-section to remove two domes, so as to leave two surfaces parallel to each other. The thickness between the two parallel surfaces is less than the thickness between their ends (the diameter of the bar), so that a 90-degree rotation of the bar inside the channel can exhibit two cross-sections of different area to the magnetic flux.

If the first element or the displaceable element is translatable, a preferred variant envisages that each part has T-shaped cross-section, and that said two T-shaped cross-sections are arranged so that

the central leg of the two T's is coincident and the heads of the T's are in diametrically opposite positions.

For example, the first element may be formed by two adjacent T-shape cross-sectioned parallelepipeds offset by 180 degrees about an axis parallel to the longitudinal axis.

The first element is, for example, manually displaceable, e.g. by means of a lever, or by means of an electric drive, e.g. a rotary electric motor.

Said generator of, or means for generating a, magnetic flux is generally a generator of uniform and always equiverse flux in the channel.

To minimize dispersions, the generator is preferably inserted within a magnetic circuit configured to convey the magnetic flux so that the flux passes through the empty channel. Even more preferably, the generator is mounted in a magnetic circuit configured to define said channel, in particular a guide having a U-shaped cross-section.

Said generator of, or means for generating a, magnetic flux may have various embodiments, e.g. an electromagnet or a permanent magnet arranged at different points of the magnetic circuit.

In particular, said generator of, or means for generating a, magnetic flux comprises two rows of magnets arranged uniformly along, and parallel to, the axis to determine in the middle of the two rows an empty space crossed by all-equiverse lines of magnetic field coming out of one row and entering the other.

Preferably, the device not only generates a return force but also a force to slidingly support the object in opposition to its weight. To generate said force, said flux generator may be used, or an auxiliary magnetic circuit may be provided. In a preferred variant, the device comprises

a second pair of equal, parallel and spaced rows of magnets arranged parallel to the axis to determine between the two rows an empty space crossed by magnetic field lines coming out of one row and entering the other, and

a second element, reactive to the magnetic field, extending parallel to the axis between the two rows of the second pair,

the rows of the second pair and the second element being able to slide relatively to each other parallel to the axis to move the object between the two positions,

wherein the second element in correspondence of said space exhibits a cross-section that, viewed in a plane orthogonal to the axis,

remains constant along the axis,

but along a direction orthogonal to an imaginary plane that contains the two rows, direction along which the weight of the object acts, has a decreasing width as it develops away from the plane.

The decrease of said width as it develops away from the plane causes the creation of a magnetic reaction force, directed orthogonally to the plane and toward said space, which tends to bring the second element back inside said space if an external force, such as the weight of the object, tends to extract it.

E.g. the second element at said space has a cross-section which, when viewed in a plane orthogonal to the axis, comprises a T-shaped or +-shaped or H-shaped portion.

In a variant, said cross-section of the second element may be obtained by coupling parts of material having different permeability, e.g. an aluminum rail portion and an iron portion.

The magnets of the second pair can be installed so that inside the second space the field lines are all equiverse or with alternating direction. In the second case, the magnets of the second pair also develop a braking action on the second element due to eddy electric currents induced in the second element.

Note, however, that the magnetic brake can also be achieved by using equiverse magnets coupled to conductive material (e.g. aluminum) contained in the rail (e.g. an aluminum coating of an iron portion).

To boost the developed force and/or develop a bearing force by exploiting only said magnetic flux generator, preferably also the cross-section of the first element, along a direction orthogonal to an imaginary plane containing the two rows of magnets and/or the flux lines crossing the channel, has decreasing width as it develops away from the plane.

The first and second pair of rows preferably lie on respective planes that are parallel, which facilitates construction of the device and promotes the symmetry of magnetic forces. For the same reason, a row of the first pair and a row of the second pair preferably lie on a plane that is parallel to a plane on which the remaining rows of the first and second pairs lie.

The first and/or second elements are preferably made of ferromagnetic material, e.g. iron, to minimize the reluctance of the magnetic circuit in which they are inserted.

The device preferably comprises an elongated support with a constant U-shaped cross-section, wherein the first and/or second pair of rows are mounted on the inner facing surfaces of the legs of the U. In addition to facilitating the mounting of the magnets and compacting the structure, the elongated support serves to close with its U-shaped cross-section a magnetic circuit to which the magnets belong. In other words, the elongated support helps closing the magnetic flux along a low reluctance path.

In the second element, the feature that in correspondence of said space it exhibits a cross-section that, viewed in a plane orthogonal to the axis, remains constant along the axis, is not essential, and may be absent if the second element comprises a displaceable element like the first element.

A second aspect of the invention relates to a door or leaf of a refrigerating cell comprising the device as in one or each of its variants.

A third aspect of the invention relates to a building door or window, comprising the device as in one or each of its variants.

A fourth aspect of the invention relates to a refrigerating cell comprising the device as in one or each of its variants.

A fifth aspect of the invention relates to a door or window of a vehicle or passenger compartment comprising the device as in one or each of its variants.

A sixth aspect of the invention relates to a method for controlling the displacement direction of said first element comprised in said support device,

wherein the magnetic force acting on the first element is reversed by increasing or reducing the width of a first cross-section of the first element viewed in a plane orthogonal to the longitudinal axis.

At the same time one can increase and decrease—respectively—the width of a second cross-section, viewed in a plane orthogonal to the longitudinal axis, of the first element, and vice versa,

the first and second cross-sections being located in the empty channel and being hit by the magnetic flux.

In particular, the first element or a displaceable part thereof is displaced to place in the empty channel different pairs of parts of the first element,

each pair having two different widths viewed in a plane orthogonal to the longitudinal axis.

the widths of a pair having inverted proportions with respect to the other pair.

In particular, to obtain the abovementioned cross-section variation, the first element or a displaceable part thereof is rotated or translated.

The device may also comprise a second element like the first element defined above. The second element acts within a second channel in which there is a second magnetic flux generated like the first one. The second channel may be exploited to generate the main load-opposing force, and the displacement of the second element may be exploited to modulate the intensity of the load-opposing force. In this case, the change in cross-section inside the channel modulates the load-opposing force.

The second channel may be, for example, that relating to said auxiliary magnetic circuit, in particular delimited by said second pair of equal parallel rows of magnets.

The advantages of the invention will be clearer from the following description of a preferred embodiment, reference being made to the attached drawing in which—

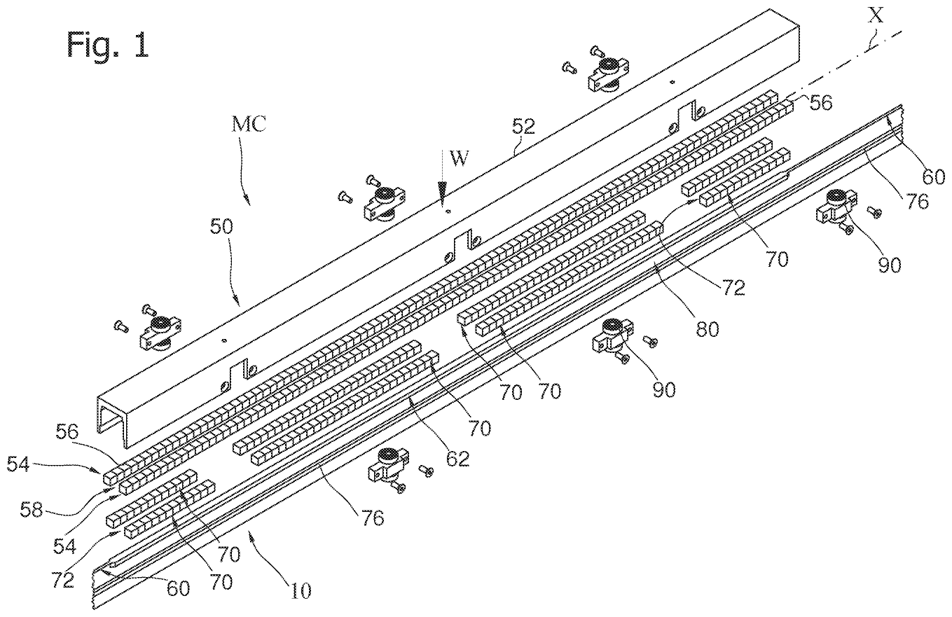

FIG. 1 shows an exploded three-dimensional view of a device;

FIG. 2a, 2b show in plan view some parts of the device;

FIG. 3 shows a vertical cross-section of the device as assembled;

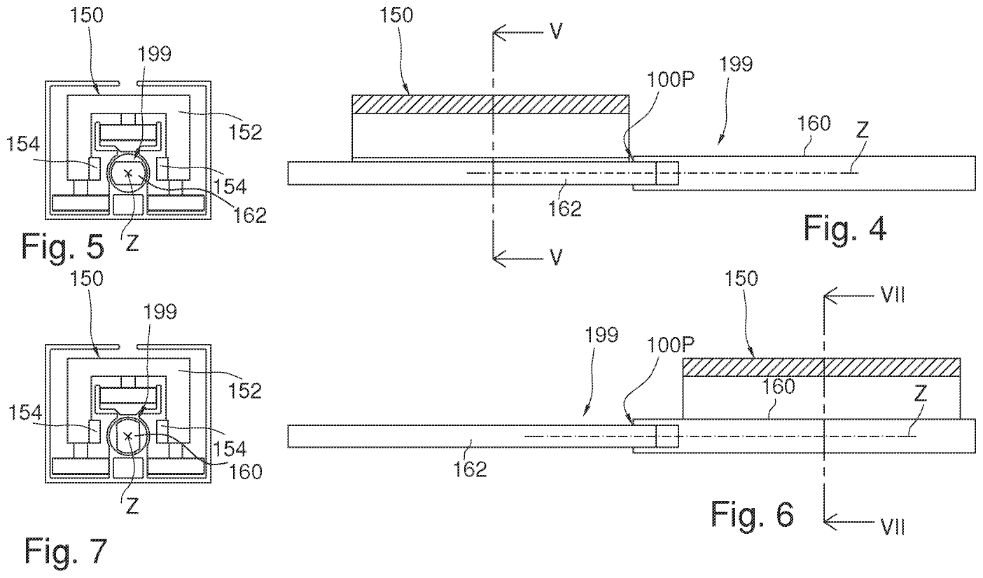

FIG. 4 shows a schematic side view of a device;

FIG. 5 shows a cross-sectional view according to the V-V plane;

FIG. 6 shows a schematic side view of the device of FIG. 4 in different configuration;

FIG. 7 shows a cross-sectional view according to the VII-VII plane;

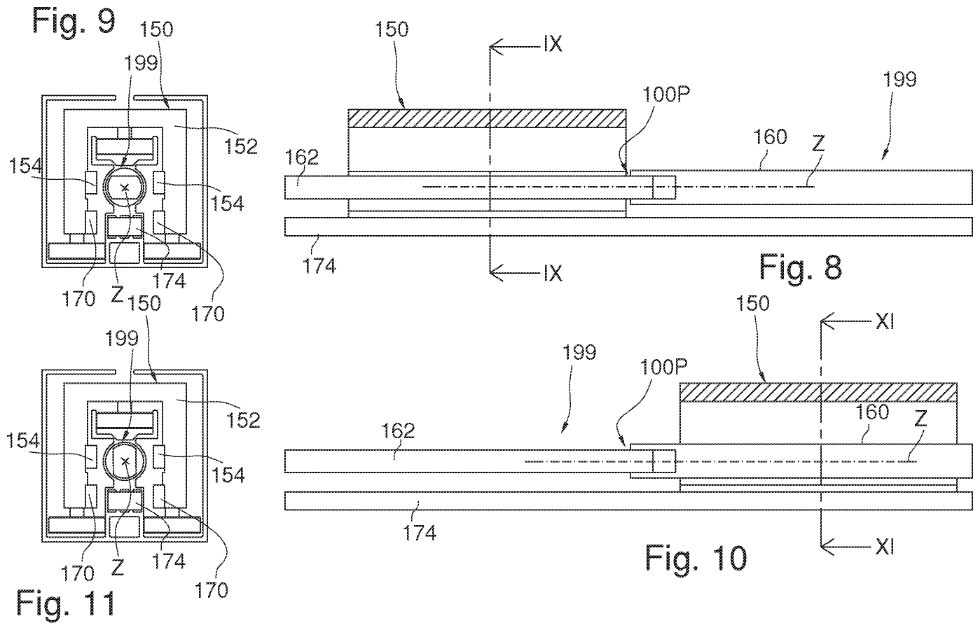

FIG. 8 shows a schematic side view of another device;

FIG. 9 shows a cross-sectional view according to the IX-IX plane;

FIG. 10 shows a schematic side view of the device of FIG. 8 in different configuration;

FIG. 11 shows a cross-sectional view according to the XI-XI plane.

In the figures equal numbers indicate equal or conceptually similar parts; the letters N and S indicate north and south magnetic poles, respectively; and arrows indicate lines of magnetic flux.

The device MC serves e.g. to slidingly support a door (not shown) along an X-axis, and is illustrated herein as the basis for an improvement object of the invention.

The device MC comprises a fixed straight track 10 and a skid 50, movable on the track 10, which can slide relatively to each other parallel to the X axis during the motion of the door. In the illustrated example, the door would be mounted on top of the skid 50, but the device MC also contemplates reversing the roles between the track 10 and skid 50 so that the former moves and the latter remains fixed.

The skid 50 comprises a body 52, having an inverted U-shaped cross-section, within which are mounted two equal, parallel and spaced rows 54 of magnets 56 uniformly arranged alongside—and parallel to—the axis X. Between the separation of the rows 54 there is thus created an empty channel 58 crossed by all-equiverse lines of magnetic field coming out of one row 54 and entering the other (see diagram in FIGS. 2a, 2b).

The fixed track 10 is mounted inside the channel 58 so as to slide.

The part of the track 10 located in correspondence of the channel 58 has a cross-section that, viewed in a plane orthogonal to the X axis and measured on the line joining the rows 54 (see plane P1 in FIG. 3), has a width L that varies as a function of the position along the X axis.

The track 10 comprises a first portion 60 and a second portion 62, and said cross-section is greater in the first portion 60 and lower in the second portion 62.

In the illustrated example, the first portion 60 has a length along the X-axis at least equal to that of the rows 54. In general, the length of the portion 60 needs to be longer than the rows 54 only if an equilibrium condition in full opening is to be guaranteed, otherwise generally this geometric feature is not necessary.

There is a discontinuity between the cross-sections of the portions 60, 62 at a point P. Such discontinuity may be abrupt, e.g. step-like, or may be gradual, such as a ramp. At point P, a magnetic force develops between the cross-sections of the portions 60, 62 and the magnetic field generated by the rows 54 of magnets.

At point P, and only at that point, a force develops tending to relatively move the track 10 and the rows 54 along the X-axis so that the portion 60 of the track 10 with smaller cross section comes out of the empty channel 58, i.e. so that the portion 60 with smaller cross-section is no longer hit by magnetic field lines.

The situation is shown in FIGS. 2a. 2b.

When inside the channel 58 there is only the portion 62 with larger cross-section (FIG. 2a), there is no retraction force.

When (FIG. 2b) the portion 60 is displaced inside the channel 58 (toward the left in the drawing), a return force F arises at the point P which tends to oppose the position change and to bring the system back as in FIG. 2a (toward the right in the drawing).

If, for example, the relative position between the track 10 and the rows 54 of FIG. 2a corresponds to the closed door position, when the door is opened (FIG. 2b) the device MC generates a force F that brings the door back to the closed position.

The force F has approximately constant amplitude, independent of the position of the point P between the rows 54.

The variation of cross-section entails a reluctance variation of the magnetic circuit, and the amplitude of the force remains almost constant because it is linked to the reluctance variation, which is also constant.

Clearly, all this is also valid for a movement in the other direction along the X-axis (i.e. by turning the FIGS. 2a, 2b upside-down), being enough that the track 10 has a symmetrical shape with respect to a plane orthogonal to the X-axis. This is the case of FIG. 1, in which for the skid 50 a magnetic force F is generated tending to bring it back to the center of the track 10 because the track 10 has two discontinuity points for the cross-sections of the portions 60, 62 that are at least as far apart as the length along X of the skid 50.

Preferably, the device MC also generates a force to slidingly support the skid 50 on the track 10.

In order to generate such a force that opposes to the load W, e.g. the track 10 at the portions 60, 62 comprises a T-shaped or +-shaped or H-shaped portion. or in general, such portion, along a direction orthogonal to an imaginary plane P1 containing the two rows 54, has a decreasing width as it develops away from the plane. In other words, preferably the cross-section of the portions 60, 62, along a direction orthogonal to the plane P1, has decreasing width as it develops away from the plane P1. Thus, this portion of the device MC also generates load-bearing force.

To increase the support force, the skid 50 preferably comprises a second pair of equal, parallel, spaced-apart rows 70 of magnets arranged parallel to the X-axis to create between the two rows 70 a second empty space or channel 72 crossed by magnetic field lines coming out of one row 70 and entering the other. Within the space 72 there is a second element 74 of the track 10 that is responsive to the magnetic field and extends parallel to the X-axis between the two rows 70.

The portion of the track 10 running inside the space 72 has a cross-section 76 that, when viewed in a plane orthogonal to the X-axis, remains constant along the X-axis but, along a direction orthogonal to an imaginary plane P2 containing the two rows 70, has a decreasing width as it develops away from the plane P2.

In the illustrated example, the cross-section 76 is included in a +-shaped portion. Other variants comprise, for example, a T- or H-shaped part for the cross-section 76, and/or the use of different material for various parts of the cross-section 76.

As illustrated, it is preferred that the portions 60, 62 and the cross-section 76 belong to a single piece, e.g. a profile for simplicity of construction, or that however they all develop from the same plane.

By the physical principles described in PCT/IB2017/052588, when the cross-section 76 moves away from the plane P2 a magnetic reaction force is created, directed orthogonally to the plane P2 and toward the space 72, which tends to bring the cross-section 76 back into the space 72. Thus the weight W of the object is opposed.

The change along the direction of the load results in a change in reluctance that generates a reaction magnetic force that tends to bring the system into the least reluctance configuration. An equilibrium position is then reached in which the magnetic force balances the load.

The magnets of the rows 70 may be installed so that the field lines are all equiverse (as in FIG. 2a) or with alternating direction. In the second case, the device MC is added the feature of incorporating a magnetic brake, caused by the eddy currents induced by the alternating magnetic field in the track 10.

The magnetic brake is advantageous because it has a viscous-type dynamic response, i.e. the braking action increases with the speed of the skid 50. Therefore, it does not significantly hinder the door during normal use but intervenes to prevent unwanted accelerations. It has therefore the effect of limiting the speed.

Note that the feature of incorporating a magnetic brake into the device is independent of the presence of the rows 54 and the means for generating the retraction force F.

To facilitate construction, in the device MC it is preferred that
the rows 54, 78 lie on respective planes P1, P2 which are parallel; and/or
one row of the two rows 54 and one of the two rows 70 lie on a plane that is parallel to the planes P1, P2.

Preferably, the portion of the track 10 corresponding to the portion 60, 62 and/or 76 is made of ferromagnetic material, e.g. iron. The track 10 may be made entirely of ferromagnetic material, e.g. iron, or may comprise a portion 80 that joins the portions 60, 62 and the cross-section 76 and is made of different material than that of the portions 60, 62 and/or 76, e.g. aluminum.

Preferably, the track 10 has a H-shaped cross-section of which the two parallel rods of the H form the cross-section of the portions 60, 62 and 76.

Preferably, the rows 70 and 54 are mounted on the inner surface of the body 52 for compactness.

Preferably, wheels 90, having a rotation axis orthogonal to the planes P1 and P2, are mounted on the body 52. The wheels (or other centering devices, e.g. sliding skids, etc.) touch the, and slide on, the track 10, and serve to facilitate the sliding of the skid 50. The wheels also serve to keep the skid centered along the transverse direction (acting as a centering device).

The device MC, in all the variants described so far, is improved according to the invention for controlling the linear movement of the skid 50, e.g. as in the variant of FIGS. 4-11. The concept is employable in a skid with magnets exploited to move the load linearly, with or without the second row of magnets 70 as in FIGS. 4-7. With appropriate design, even a single row of magnets can support a load, albeit a small load.

The portions common to the basic device MC retain the same numbers increased by 100, and are not described again. Unlike the device MC, the portion 60 and the portion 62 are no longer integral with the track 10 but belong to an elongated element 199 that is mounted within the channel between the rows 154 and is rotatable with respect to the skid 50.

The element 199 extends along a Z-axis parallel to the X-axis, and is formed by the juxtaposition of two (e.g. equal) parallelepipeds 160, 162 having a rectangular cross-section (or base).

The parallelepipeds 160, 162 have major axis (the height) coaxial to the Z axis, are placed abutted to each other (adjacent) along the Z axis and offset angularly by 90 degrees about the Z axis.

At the point of conjunction of the parallelepipeds 160, 162 a cross-section discontinuity 100P is formed, like the discontinuity between the cross-sections of the portions 60, 62 at point P, because the base of the parallelepiped 160 joins the base of the parallelepiped 162 intersecting it orthogonally. That is to say that when looking at the element 199 from the front, namely placing oneself on the Z axis, a cross is viewed. The two different cross-sections of the parallelepipeds 160, 162 are visible in FIGS. 5 and 7.

The element 199 is movable with respect to the skid 150, in particular rotatable about the Z-axis, for example manually or by means of an electric actuator.

As a result, a 90-degree rotation of the element 199 can vary the cross-section of the material that lies in the channel 158 between the rows 154 of magnets. If earlier the parallelepiped 160 had exhibited a wide cross-section, corresponding to the long side of its rectangular cross-section, after the rotation such cross-section becomes narrow, corresponding to the short side of the rectangular cross-section. At the same time, if earlier the parallelepiped 162 had exhibited a narrow cross-section, corresponding to the short side of its rectangular cross-section, after the rotation its cross-section in the channel becomes wide, corresponding to the long side of the rectangular cross-section.

Another rotation of the element 199 reverses again the relationship between the widths that the cross-sections of the parallelepipeds 160, 162, taken in a plane orthogonal to the Z axis, exhibit in the channel 158.

Note that the position along the Z-axis of the cross-section discontinuity 100P does not vary with the rotation of element 199.

By what has been explained above for the device MC, it is understood that a 90-degree rotation of the element 199 results in the reversal of the magnetic force F that moves the skid 150 along the X (and Z) axis. The effect of the rotation of element 199 is equivalent, in FIG. 2b, to the track 10 being pulled out of the channel, rotated by 180 degrees, and put back into the channel.

The modification of the cross-sections made of ferromagnetic material present in the channel is implemented by a displacement of the element 199, in the illustrated case through a rotation. A translation may be used if the movable element has e.g. two parts with T-shaped cross-sections, the two T-shaped cross-sections being rotated by 180 degrees about the Z-axis.

In a simpler variant, the cross-section discontinuity 100P is also obtainable if the element 199 has only one of the rotatable parallelepipeds 160, 162 and the other is fixed.

The same concept can be employed in a skid 150 with auxiliary magnets 170 for supporting the load, as already explained in FIG. 3. See FIGS. 8-11 for this variant.

In a variant, even between the magnets 170 there may be a displaceable element such as the element 199 to modulate the load-bearing force.

1. Support device for slidingly supporting, and linearly moving along a longitudinal axis, an object such as e.g. a leaf, comprising:
an empty channel extending parallel to the longitudinal axis;
a magnetic flux generator for creating a magnetic flux which crosses a segment of the empty channel with magnetic field lines all having the same direction,
a first element, reactive to the magnetic field, which
is mounted in the empty channel and extends along said longitudinal axis, can slide relatively to the channel parallel to the longitudinal axis during the displacement of the object, and
in correspondence of said segment has a cross-section struck by the magnetic flux, which cross-section, viewed in a plane orthogonal to the longitudinal axis, has a dimension along the width of the channel,
wherein the first element comprises a displaceable element for increasing or decreasing the width of said cross-section, so that the first element is configured in such a way that a displacement of the displaceable element entails to an increase or decrease in the width of said cross-section.

2. Device according to claim 1, wherein the first element comprises a displaceable element for
increasing the width of a first cross-section of the first element viewed in a plane orthogonal to the longitudinal axis and
at the same time decreasing the width of a second cross-section of the first element viewed in a plane orthogonal to the longitudinal axis, and vice versa, the first and second cross-sections being aligned inside the empty channel along the axis of the channel and being struck by the magnetic flux.

3. Device according to claim 2, wherein the first element
comprises two parts aligned along the longitudinal axis and integral with each other,
each part comprising a first and a second portion adapted to engage the empty channel and respectively exhibit therein a cross-section which, viewed in a plane orthogonal to the longitudinal axis, has a first and a second dimension along the width of the channel
the first dimension being larger than the second dimension, and
the larger cross-section of the first part being aligned with the smaller cross-section of the second part, and
the smaller cross-section of the first part being aligned with the larger cross-section of the second part,
and is mounted movable with respect to the generator to alternatively place inside the channel the portion with smaller dimension of one part and the portion with larger dimension of the other part.

4. Device according to claim 1, wherein the first element and/or the displaceable element is rotatably mounted about an axis parallel to the longitudinal axis.

5. Device according to claim 4, wherein each said part has a rectangular or substantially rectangular cross-section, and such two cross-sections are arranged so that
the rotation axis of the first element passes through the intersection of the diagonals of each cross-section, and
the long sides of one cross-section are parallel to the short sides of the other cross-section.

6. Device according to claim 5, wherein the first element, is formed by two adjacent parallelepipeds with a rectangular or substantially rectangular cross-section, which are coaxial and offset by 90 degrees about the common rotation axis.

7. Device according to claim 1, wherein the first element and/or the displaceable element is mounted translatable with respect to the longitudinal axis.

8. Device according to claim 1, wherein the generator inserted inside a magnetic circuit configured for
conveying the magnetic flux so that the flux passes through the empty channel, and
defining said channel.

9. Device according to claim 1, wherein the generator comprises two rows of magnets arranged uniformly along, and parallel to, the longitudinal axis to determine between the two rows one empty space crossed by magnetic field lines having all the same direction and coming out of one row and entering the other.

10. Device according to claim 1, comprising:
a second pair of equal parallel and spaced rows of magnets arranged parallel to the axis to determine in the middle of the two rows an empty space crossed by magnetic field lines exiting from one row and entering the other, and
a second element, reactive to the magnetic field, which extends parallel to the axis between the two rows of the second pair,
the rows of the second pair and the second element being able to slide relatively to each other parallel to the axis move the object between two positions,
wherein the second element at said space has a cross-section which, viewed in a plane orthogonal to the axis, along a direction orthogonal to an imaginary plane containing the two rows, direction along which a load weights, has a decreasing width along said orthogonal direction as it develops away from the imaginary plane, the second element comprising a displaceable element such as that of the first element.

11. Device according to claim 2, wherein the first element and/or the displaceable element is rotatably mounted about an axis parallel to the longitudinal axis.

12. Device according to claim 3, wherein the first element and/or the displaceable element is rotatably mounted about an axis parallel to the longitudinal axis.

14. Device according to claim 2, wherein the first element and/or the displaceable element is mounted translatable with respect to the longitudinal axis.

15. Device according to claim 3, wherein the first element and/or the displaceable element is mounted translatable with respect to the longitudinal axis.

17. Device according to claim 8, wherein the generator comprises two rows of magnets arranged uniformly along, and parallel to, the longitudinal axis to determine between the two rows one empty space crossed by magnetic field lines having all the same direction and coming out of one row and entering the other.

18. Device according to claim 9, wherein the generator comprises two rows of magnets arranged uniformly along, and parallel to, the longitudinal axis to determine between the two rows one empty space crossed by magnetic field lines having all the same direction and coming out of one row and entering the other.

19. Device according to claim 8, comprising:
a second pair of equal parallel and spaced rows of magnets arranged parallel to the axis to determine in the middle of the two rows an empty space crossed by magnetic field lines exiting from one row and entering the other, and
a second element, reactive to the magnetic field, which extends parallel to the axis between the two rows of the second pair,
the rows of the second pair and the second element being able to slide relatively to each other parallel to the axis to move the object between two positions,
wherein the second element at said space has a cross-section which, viewed in a plane orthogonal to the axis, along a direction orthogonal to an imaginary plane containing the two rows, direction along which a load weights, has a decreasing width along said orthogonal direction as it develops away from the imaginary plane, the second element comprising a displaceable element such as that of the first element.

20. Device according to claim 9, comprising:
a second pair of equal parallel and spaced rows of magnets arranged parallel to the axis to determine in the middle of the two rows an empty space crossed by magnetic field lines exiting from one row and entering the other, and
a second element, reactive to the magnetic field, which extends parallel to the axis between the two rows of the second pair,
the rows of the second pair and the second element being able to slide relatively to each other parallel to the axis to move the object between two positions,
wherein the second element at said space has a cross-section which, viewed in a plane orthogonal to the axis, along a direction orthogonal to an imaginary plane containing the two rows, direction along which a load weights, has a decreasing width along said orthogonal direction as it develops away from the imaginary plane, the second element comprising a displaceable element such as that of the first element.
